(19) United States
(12) Patent Application Publication
(10) Pub. No.: US 2022/0387243 A1
(43) Pub. Date: Dec. 8, 2022

(54) Stretching Machine

(71) Applicant: Gregg M Guenther, Chandler, AZ (US)

(72) Inventor: Gregg M Guenther, Chandler, AZ (US)

(21) Appl. No.: 17/310,986

(22) PCT Filed: Feb. 11, 2021
(86) PCT No.: PCT/US2021/070139

§ 371 Date: Sep. 3, 2021

Related U.S. Application Data
(63) Continuation of application No. PCT/US2020/070731, filed on Oct. 31, 2020.

(51) Int. Cl. A61H 1/02

(52) U.S. Cl. CPC A61H 1/0237; A61H 1/0292; A61H 2201/0192; A61H 2201/1253; A61H 2201/169; A61H 2201/5056; A61H 2203/0425; A61H 2203/0456; A61H 2203/0468

(57) ABSTRACT

The present invention is a Stretching Machine in the form of a remote power actuated mechanical pushing apparatus comprising a flat base extended in front of an open box frame having a power actuated mechanical pushing and pulling device with a plurality of cylindrical padded arms enabling a full one hundred and eighty degree arc range of effective powered stretching assistance for self stretching the lower back muscles and leg muscles for exercise, physical therapy, rehabilitation, and stretching. It is useful for actively and passively, safely and effectively, self stretching the erector spinae, hamstrings, quadriceps, sartorius, hip adductors, hip flexors, tensor fasciae latae, rectus femris, gluteus maximus, and gluteus medius muscles. The Stretching Machine is also convenient and easy to use to stretch the muscles of the upper back.

### TECHNICAL FIELD OF THE INVENTION

This invention relates generally to a stretching machine in the form of a remote controlled power actuated mechanical pushing apparatus for self stretching the muscles of a human. This invention relates generally to a stretching machine in the form of a remote controlled power actuated mechanical pushing apparatus for self stretching the lower back muscles and leg muscles for exercise, physical therapy rehabilitation, and stretching.

The present invention relates specifically to a stretching machine for safe and effective power-assisted, full range of motion self stretching of human muscles without the use of opposing contracting muscles. The present invention relates specifically to a stretching machine for safe and effective power-assisted, full range of motion self stretching of human muscles without the use of opposing contracting muscles for the muscles of the erector spinae, hamstrings, quadriceps, sartorius, hip adductors, hip flexors, tensor fasciae latae, rectus femris, gluteus maximus, and gluteus medius muscles.

### BACKGROUND

There are a litany of devices and techniques for exercising and stretching the muscles of the lower back and legs. There are mechanical and power assisted exercise machines intended for moving the muscles of the lower back and legs. There are mechanical and power assisted exercise machines intended for stretching the muscles of the lower back and legs.

There exists a need for a stretching machine to enable assisted self stretching of the muscles of the lower back and legs throughout up to a full one hundred and eighty degree arc range of motion.

### BRIEF SUMMARY OF THE INVENTION

The present invention is a stretching machine for self stretching muscles of a combination of an user's lower back muscles and an users leg muscles comprising an open box frame having a connectively attached extendable base twice the length of said open box frame wherein said open box frame comprises a hinge connectively attached at the upper front center of said open box frame to a vertical support riser having a plurality of padded horizontal support arms connectively attached along the length of said vertical support riser and a remote controlled power actuated push rod actuator connectively attached by a hinge at the midpoint along the length of said vertical support riser and connectively attached by a hinge at the lower rear center of said open box frame enabling the remote controlled power assisted self stretching of a combination of an user's lower back muscles and an user's leg muscles by advancing or retracting the remote controlled power actuated push rod actuator to advance the vertical support riser from between zero and one hundred and eighty degrees of arc about the hinge connecting said vertical support riser to said open box frame.

In a first embodiment, there is a stretching machine apparatus for physical human exercise, comprising a box frame having a base to rest on a surface, said base having a first edge rotatably connected to a first edge of a rectangular panel, and said first edge of said base also rotatably connected to a distal end of an elongated riser such that said panel and riser swing around said first edge of said frame in the same plane, a user variable length push-pull rod having a first end pivotably connected to said riser intermediate said free end and said distal end and a second end pivotably connected to a second edge of said frame distal from said first edge, wherein said riser is urged to rotate from/to proximately parallel to the base of the frame to/from proximately parallel to the panel by a user varying the length of said push-pull rod.

In a second embodiment, according to the invention, there is a stretching machine apparatus where said riser comprises a bar including the distal end and a free end.

In a third embodiment, according to the invention, there is a stretching machine apparatus wherein where said riser comprises a plurality of arms extending from either side the bar so as to be parallel to the panel when the riser is parallel to the panel.

In a third embodiment, according to the invention, there is a stretching machine apparatus wherein the arms are padded.

In a fourth embodiment, according to the invention, there is a stretching machine apparatus comprising a user operable remote control to vary the length of the push-pull rod and thereby the rotated position of the riser with respect to the frame.

In a fifth embodiment, according to the invention, there is a stretching machine apparatus wherein said panel comprises a section including said first edge of the rectangular panel and an opposite parallel edge connected by a hinge a to rectangular extension such the extension is arranged to swing about said section in the same plane that said panel and riser swing.

In a sixth embodiment, according to the invention, there is a stretching machine apparatus wherein the riser swings independently from the panel.

In a seventh embodiment, according to the invention, there is a stretching machine apparatus wherein said first edge of said panel has a width substantially equal to that of said first edge of said frame.

In an eighth embodiment, according to the invention, there is a stretching machine apparatus wherein the length of the first panel from its first edge connected to the frame is substantially equal to the length of the frame from its first edge connected to the panel.

In a ninth embodiment, according to the invention, there is a stretching machine apparatus wherein the panel is arranged to fold into the frame swinging a first direction.

In a tenth embodiment, there is a stretching machine apparatus wherein the base further comprises a bench.

In an eleventh embodiment, according to the invention, there is a stretching machine apparatus wherein said first edge of said panel has a width substantially equal to that of said first edge of said frame.

In a twelfth embodiment, according to the invention, there is a stretching machine apparatus A method of using the stretching machine of claim 1 to stretch a muscle having a connected joint by applying a mechanical force through a range of motion up to 180 degrees of arc about said connected joint enabling the stretching of said muscle without the need to use of any of said muscles associated contracting muscles.

An advantage of the full one hundred and eighty degree arc range of effective assistance is that, due to the extended base of the apparatus, the user is able to self stretch with power actuated mechanical assisted pushing throughout the entire human range of motion (up to one hundred eighty degrees of rotation) enabling safe and effective self stretching the erector spinae, ham-strings, quadriceps, sartorius, hip adductors, hip flexors, tensor fasciae latae, Rectus femris, gluteus maximus, and gluteus medius muscles. The stretching machine is also convenient and easy to use for self stretching muscles of an user's upper back muscles.

The invention will now be described, by way of example only, with reference to the accompanying drawings in which:

### BRIEF DESCRIPTION OF THE DRAWINGS

FIG. 1 shows a perspective view of the stretching machine showing the base extended and the power actuated mechanical pushing apparatus at its ninety degree movement position;

FIG. 2 shows a side view of the apparatus of the present invention in use showing a seated user stretching their lower back and leg muscles from a seated position;

FIG. 3 shows a side view of the apparatus of the present invention in use showing a supine user stretching their lower back and leg muscles from a supine position;

FIG. 4 shows a side view of the apparatus of the present invention in use showing a seated user with their right leg crossed over the left stretching their lower back and leg muscles from a seated position;

FIG. 5 shows a side view of the apparatus of the present invention in use showing a supine user with their right leg crossed over the left stretching their lower back and leg muscles from a supine position; and

FIG. 6 shows a side view of the apparatus of the present invention in use showing a prone user stretching their lower back and leg muscles from a prone position using the power actuated mechanical pushing apparatus well beyond the ninety degree movement position.

### DETAILED DESCRIPTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

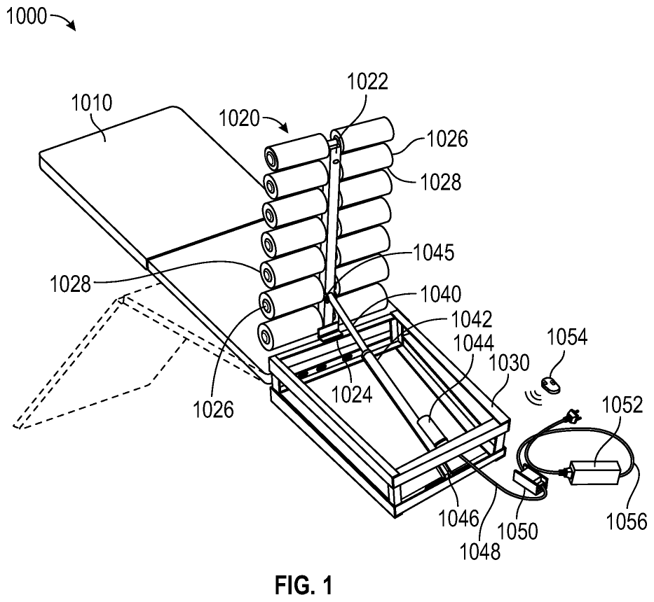

Referring to the Figures, there is shown in FIG. 1, Element 1000 which is the Stretching machine.

Index of Labelled Elements in Figures (in Numeric Order):

Element 1010 is the open frame base.

Element 1020 is the power actuated mechanical pushing device.

Element 1022 is the vertical support riser.

Element 1024 is the vertical support hinge.

Element 1026 is a horizontal support arm(s).

Element 1028 is the support arm pad(s).

Element 1030 is the open box frame.

Element 1040 is the inner actuator push rod.

Element 1042 is the outer actuator push rod.

Element 1044 is the actuator activator.

Element 1045 is the actuator arm hinge.

Element 1046 is the actuator box hinge.

Element 1048 is the actuator control connection.

Element 1050 is the actuator control.

Element 1052 is the actuator power supply.

Element 1054 is the remote control.

Element 1056 is the electrical power cord.

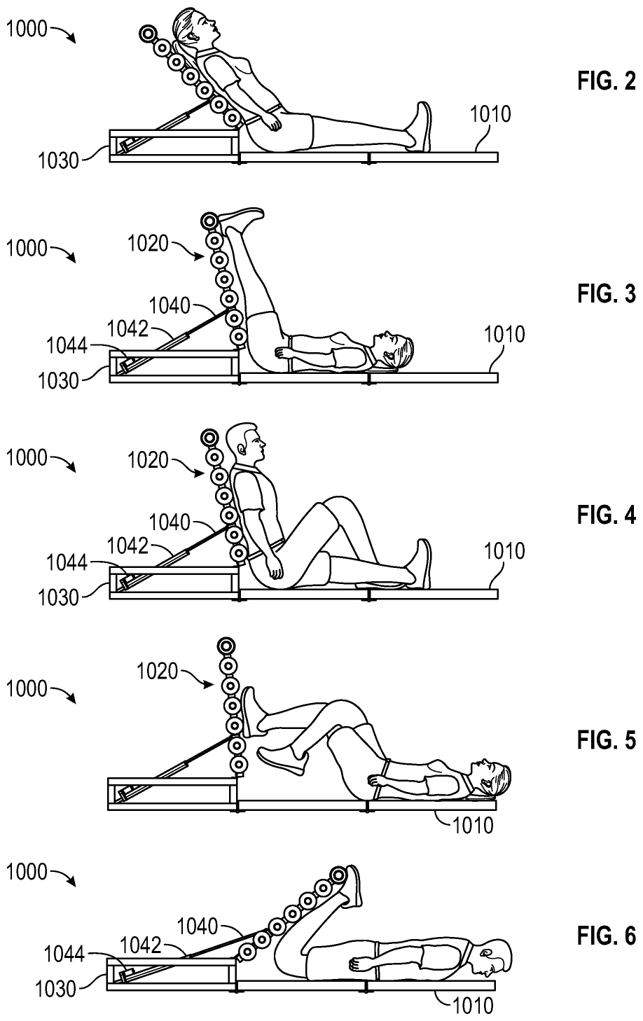

Referring to the Figures, FIG. 2 shows a side view showing a seated user stretching their lower back and leg muscles from a seated position. FIG. 3 shows a side view showing a supine user stretching their lower back and leg muscles from a supine position. FIG. 4 shows a side view showing a seated user with their right leg crossed over the left stretching their lower back and leg muscles from a seated position. FIG. 5 shows a side view showing a supine user with their right leg crossed over the left stretching their lower back and leg muscles from a supine position. FIG. 6 shows a side view showing a prone user stretching their lower back and leg muscles from a prone position using the power actuated mechanical pushing apparatus well beyond the ninety degree movement position. These positions can be used to stretch any of the lower back and leg muscles.

In an embodiment, the open frame base (1010) is a solid flat open board slide out base. In an embodiment the open frame base (1010) is a multiple piece slide out open frame assembly. In an embodiment, the open frame base (1010) is a multiple piece slide out solid board base. In an embodiment, the open frame base (1010) is a bench least twice as long as the width of the open box frame.

In an embodiment the support arm pads (1028) which are connectively attached to and surrounding the horizontal support arms (1026) comprise cylindrical shaped supportive foam tubes that are slid over and positioned around and over the horizontal support arms (1026) to create a softer more complaint surface against which to push, placing pressure (force), to stretch the muscles. The foam tubes are made from available materials depending on intended purpose. The foam tubes may be made stiffer or more complaint depending on the material availability and selection. The dimensions of the support arm pads (1028) are determined by the dimensions of the horizontal support arms (1026). A larger outer surface area for the support arm pads (1028) results in a larger more padded surface for increased comfort and increased surface area of con-tact with the body of the user.

In an embodiment, there is a push rod actuator which is a pneumatic actuator having positive pushing force when advancing. This push rod actuator is comprised of the inner actuator push rod (1040), the outer actuator push rod (1042), the actuator activator (1044), the actuator control connection (1048), the actuator control (1050), the actuator power supply (1052), the remote control (1054), and the electrical power cord (1056).

The open frame base (1010) can be configured as fixed or foldable, but in either case ex-tends the open frame base (1010) of the stretching machine (1000) outward in front the machine offering a convenient location from which to self stretch various combinations of muscles. In a preferred embodiment, the muscles that are self stretched using the invention include, but are not limited to the following: the erector spinae, hamstrings, quadriceps, sartorius, hip adductors, hip flexors, tensor fasciae latae, Rectus femris, gluteus maximus, and gluteus medius muscles by us ing the stretching machine's (1000) remote control (1054) to advance or retract the inner actuator push rod (1040) and the outer actuator push rod (1042) to stretch the muscle without the use of opposing contracting muscles.

The present invention is a stretching machine (1000) for self stretching one's muscles. A typical use of the present invention is to stretch a combination of an user's lower back muscles and an user's leg muscles. However, it is noted that the apparatus/device of the present invention enables the stretching of any muscles that can be positioned such that one connected joint of a muscle is proximal to the point of connection between the vertical support riser (1022) adjacent to the edge of the open frame base (1010) where the vertical support hinge (1024) connects the vertical support riser (1022) and the open frame base (1010) such that the vertical support riser (1022) can be advanced by the push rod actuator to enable stretching of said muscle without the need to use of any of that muscles opposing contracting muscles. This enables a more complete and easier to sustain self stretching of the muscles that can be controlled.

The present invention is a stretching machine (1000) for self stretching one's muscles to facilitate movement and extension of the muscle, comprising an open box frame (1030) having a connectively attached extendable base (1010) twice the length of said open box frame (1030) wherein said open box frame (1030) comprises a vertical support hinge (1024) connectively attached at the upper front center of said open box frame (1030) to a vertical support riser (1022) having a plurality of padded horizontal support arms (1026) connectively attached along the length of said vertical support riser (1022) and a remote controlled (1054) power actuated push rods (1040, 1042) connectively attached by an actuator arm hinge (1045) at the midpoint along the length of said vertical support riser (1022) and connectively attached by an actuator box hinge (1046) at the lower rear center of said open box frame (1030) enabling the remote controlled (1054) power assisted self stretching of a combination of an user's lower back muscles and an user's leg muscles by advancing or retracting the remote controlled (1054) power actuated push rods (1040, 1042) to advance the vertical support riser (1022) from between zero and one hundred and eighty degrees of arc about the hinge connecting said vertical support riser (1022) to said open box frame (1030).

In the preferred embodiment, the open frame base (1010) of the stretching machine (1000) is foldable so as to collapse into the open box frame (1030) wherein the foldable sections are hingedly attached to each other end to end, and one free end of one section is hingedly attached to the open box frame (1030).

In an alternative embodiment, the open frame base (1010) is a fixed length frame or solid panel at least as long as the width of the open box frame (1030). In an alternative embodiment the open frame base (1010) is a bench at least as long as the width of the open box frame (1030).

In an embodiment, the padded horizontal support arms (1026) comprise a cylindrical shaped supportive foam support arm pad (1028) wrapped around a horizontal support arm (1026). In alternative embodiments the padding (1028) is supportive gel foam tubes, rubber coated foam tubes, rubber coated supportive gel foam tubes.

In the preferred embodiment, the padded horizontal support arms (1026) comprise light weight metal rods for the horizontal support arms (1026) and water resistant supportive foam tubes wrapped around said horizontal support arms (1026) for the support arm pads (1028). In a preferred embodiment there are seven horizontal support arms extended from either side of the vertical support riser (1022).

In alternative embodiments, the horizontal support arms (1026) are rods of wood, metal, or plastic used as the center rod with any of the padding tube types for the support arm pads (1028). Any rigid rod and padding combination desired can be utilized to customize the apparatus of the present invention. In alternative embodiments, there are one or more horizontal support arms ex-tended from either side of the vertical support riser (1022).

In an embodiment, the push rod actuator is a pneumatic actuator having positive pushing force when advancing. In an embodiment, the push rod actuator is a pneumatic actuator having positive pushing force when advancing and retracting. In an embodiment, the push rod actuator is a screw drive extended telescoping actuator having positive pushing force when advancing. In an embodiment, the push rod actuator is a screw drive extended telescoping actuator having positive pushing force when advancing and retracting.

In all embodiments the open box frame (1030), is either open, filled, screen, or solid when forming a connectively attached foldable base with a plurality of sections that flatten out forward to the front of the apparatus thereby effectively and efficiently moving the weight anchor point of the device forward of the hinged pivot position of the power actuated mechanical pushing device (1020) thereby enabling the application of a pushing force to stretch the muscles wherein a connected joint of said muscle is proximal to the front face of the open box frame (1030) at the point of connection of the vertical support hinge (1024) such that the vertical support riser (1022) will have the force from the power actuated mechanical pushing of the push rod actuator applied. In an alternative embodiment, the open box frame (1030) further comprises a bench, and is connectively attached to, or an integrated part of said bench.

It is the open frame base (1010) extending flat out in front of the open box frame (1030) that places the weight of the user sitting in position to use the apparatus from the front of the apparatus thereby anchoring the apparatus and enabling the full one hundred and eighty degree arc range of effective assistance to the user to enable self stretching with power actuated mechanical assisted pushing throughout the entire human range of motion (up to one hundred eighty degrees of rotation) enabling safe and effective self stretching of the erector spinae, hamstrings, quadriceps, sartorius, hip adductors, hip flexors, tensor fasciae latae, rectus femris, gluteus maximus, and gluteus medius muscles. In an alternate embodiment, there is a stretching machine (1000) wherein said stretching machine (1000) is for self stretching muscles of an user's upper back muscles. The present invention enables the stretching of any muscle or muscle group positioned within the apparatus for stretching according to the invention.

In a preferred embodiment, there is a stretching machine (1000) for self stretching muscles of an user's lower back muscles and an user's leg muscles comprising an open box frame (1030) having a connectively attached extendable open frame base (1010) at least the length of said open box frame (1030) wherein a vertical support hinge (1024) connectively attached at the up-per front center of said open box frame (1030) to a vertical support riser (1022) having a plurality of padded horizontal support arms (1026) connectively attached along the length of said vertical support riser (1022) and a remote controlled (1054) power actuated push rod actuator connectively attached by an actuator arm hinge (1045) at the midpoint along the length of said vertical support riser (1022) and connectively attached by an actuator box hinge (1046) at the lower rear center of said open box frame (1030) enabling the remote controlled (1054) power assisted self stretching of an user's lower back muscles and an user's leg muscles by advancing or retracting the power actuated push rod actuator to advance the vertical support riser (1022) from between zero and one hundred and eighty degrees of arc about the hinge connecting said vertical support riser (1022) to said open box frame (1030). Said stretching machine (1000) thereby enables the remote controlled (1054) power assisted self stretching of an user's lower back muscles and an user's leg muscles by advancing or retracting the remote controlled (1054) power actuated push rod actuator to advance the vertical support riser (1022) from between zero and one hundred and eighty degrees of arc about the vertical support hinge (1024) connecting said vertical support riser (1022) to said open box frame (1030).

In an alternate embodiment, there is a stretching machine (1000) wherein said push rod actuator is a pneumatic actuator having positive pushing force when advancing.

In an alternate embodiment, there is a stretching machine (1000) wherein said push rod actuator is a pneumatic actuator having positive pushing force when advancing and retracting.

In an alternate embodiment, there is a stretching machine (1000) wherein said push rod actuator is a screw drive extended telescoping actuator having positive pushing force when advancing and retracting.

In an alternate embodiment, there is a stretching machine (1000) wherein said padded horizontal support arms (1026) comprise cylindrical shaped supportive foam tubes wrapped around a rod.

In an embodiment, there is a stretching machine (1000) for self stretching muscles comprising an open box frame (1030) having a connectively attached bench base at least twice the length of said box frame wherein said box frame comprises a hinge connectively attached at the upper front center of said box frame to a vertical support riser having a plurality of support arm padded horizontal support arms (1026) connectively attached along the length of said vertical support riser (1022) and a remote controlled (1054) power actuated push rod actuator connectively attached by a hinge at the midpoint along the length of said vertical support riser and connectively attached by a hinge at the lower rear center of said box frame enabling the remote controlled (1054) power assisted self stretching of an user's lower back muscles and an user's leg muscles by advancing or retracting the remote controlled (1054) power actuated push rod actuator to advance the vertical support riser from between zero and one hundred and eighty degrees of arc about the hinge connecting said vertical support riser to said box frame.

In an alternate embodiment, there is a stretching machine (1000) wherein said stretching machine (1000) is integrated into said bench.

In a preferred embodiment, there is a stretching machine (1000) apparatus for physical human exercise, comprising a box frame having a base to rest on a surface, said base having a first edge rotatably connected to a first edge of a rectangular panel, and said first edge of said base also rotatably connected to a distal end of an elongated riser such that said panel and riser swing around said first edge of said frame in the same plane, a user variable length push-pull rod having a first end pivotably connected to said riser intermediate said free end and said distal end and a second end pivotably connected to a second edge of said frame distal from said first edge, wherein said riser is urged to rotate from/to proximately parallel to the base of the frame to/from proximately parallel to the panel by a user varying the length of said push-pull rod.

In an alternate embodiment, there is a stretching machine (1000) where said riser comprises a bar including the distal end and a free end.

In an alternate embodiment, there is a stretching machine (1000) wherein where said riser comprises a plurality of arms extending from either side the bar so as to be parallel to the panel when the riser is parallel to the panel.

In an alternate embodiment, there is a stretching machine (1000) wherein the arms are padded.

In an alternate embodiment, there is a stretching machine (1000) comprising a user operable remote control to vary the length of the push-pull rod and thereby the rotated position of the riser with respect to the frame.

In an alternate embodiment, there is a stretching machine (1000) wherein said panel comprises a section including said first edge of the rectangular panel and an opposite parallel edge connected by a hinge a to rectangular extension such the extension is arranged to swing about said section in the same plane that said panel and riser swing.

In an alternate embodiment, there is a stretching machine (1000) wherein the riser swings independently from the panel.

In an alternate embodiment, there is a stretching machine (1000) wherein said first edge of said panel has a width substantially equal to that of said first edge of said frame.

In an alternate embodiment, there is a stretching machine (1000) wherein the length of the first panel from its first edge connected to the frame is substantially equal to the length of the frame from its first edge connected to the panel.

In an alternate embodiment, there is a stretching machine (1000) wherein the panel is arranged to fold into the frame swinging a first direction.

In an alternate embodiment, there is a stretching machine (1000) wherein the base further comprises a bench.

In the preferred embodiment, there is a method of using the stretching machine (1000) of claim 1 to stretch a muscle having a connected joint by applying a mechanical force through a range of motion up to 180 degrees of arc about said connected joint enabling the stretching of said muscle without the need to use of any of said muscles associated contracting muscles.

An advantage of the full one hundred and eighty degree arc range of effective assistance is that, due to the extended base of the apparatus, the user is able to self stretch with power actuated mechanical assisted pushing throughout the entire human range of motion (up to one hundred eighty degrees of rotation) enabling safe and effective self stretching the erector spinae, ham-strings, quadriceps, sartorius, hip adductors, hip flexors, tensor fasciae latae, Rectus femris, gluteus maximus, and gluteus medius muscles. The stretching machine (1000) is also convenient and easy to use for self stretching muscles of an user's upper back muscles.

The apparatus may be used to self stretch the muscles of the legs and lower back by sitting, kneeling, laying, prone, supine, or on one's side in front of the apparatus and using the remote control (1054) to advance or retract the vertical support riser (1022) allowing the vertical support riser (1022) to push or pull as needed to stretch a given muscle group. The apparatus may thus be used to push applying gentle pressure to stretch the muscles situated so as to be stretched when the vertical support riser (1022) advances or retracts pushing or pulling a muscle or group of muscles as determined by the body, leg, and arm position of the user.

The apparatus may be used to self stretch the upper back muscles as by sitting, kneeling, laying, prone, supine, or on one's side in front of the apparatus gripping it, or alternatively attaching a handhold handle and using the remote control (1054) to advance or retract the vertical sup-port riser (1022) allowing the vertical support riser (1022) to push or pull as needed to stretch a given muscle group.

The apparatus of present invention may be used to stretch any muscle group positioned so that the vertical support riser (1022) is positioned to push or pull as needed to stretch the given muscle group so positioned. The apparatus of present invention is as convenient and easy to use for self stretching muscles of an user's upper back muscles, as for the lower back and leg muscles.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suit-able modifications and equivalents may be resorted to, falling within the scope of the claims.

Although the invention has been explained in relation to various embodiments, it is to be understood that many other possible modifications and variations can be made without departing from the spirit and scope of the invention.

1. A stretching machine apparatus for physical human exercise, comprising a box frame having a base to rest on a surface, said base having a first edge rotatably connected to a first edge of a rectangular panel, and said first edge of said base also rotatably connected to a distal end of an elongated riser such that said panel and riser swing around said first edge of said frame in the same plane, a user variable length push-pull rod having a first end pivotably connected to said riser intermediate said free end and said distal end and a second end pivotably connected to a second edge of said frame distal from said first edge, wherein said riser is urged to rotate from/to proximately parallel to the base of the frame to/from proximately parallel to the panel by a user varying the length of said push-pull rod.

2. The stretching machine according to claim 1 where said riser comprises a bar including the distal end and a free end.

3. The stretching machine according to claim 1 where said riser comprises a bar including the distal end and a free end wherein where said riser comprises a plurality of arms extending from either side the bar so as to be parallel to the panel when the riser is parallel to the panel.

4. The stretching machine according to claim 1 where said riser comprises a bar including the distal end and a free end wherein where said riser comprises a plurality of arms extending from either side the bar so as to be parallel to the panel when the riser is parallel to the panel wherein the arms are padded.

5. The stretching machine according to claim 1 comprising a user operable remote control to vary the length of the push-pull rod and thereby the rotated position of the riser with respect to the frame.

6. The stretching machine according to claim 1 wherein said panel comprises a section including said first edge of the rectangular panel and an opposite parallel edge connected by a hinge a to rectangular extension such the extension is arranged to swing about said section in the same plane that said panel and riser swing.

7. The stretching machine according to claim 1 wherein the riser swings independently from the panel.

8. The stretching machine apparatus according to claim 1 wherein said first edge of said panel has a width substantially equal to that of said first edge of said frame.

9. The stretching machine according to claim 1 wherein the length of the first panel from its first edge connected to the frame is substantially equal to the length of the frame from its first edge connected to the panel.

10. The stretching machine according to claim 1 wherein the panel is arranged to fold into the frame swinging a first direction.

11. The stretching machine according to claim 1 wherein the base further comprises a bench.

12. A method of using the stretching machine to stretch a muscle having a connected joint by applying a mechanical force through a range of motion up to 180 degrees of arc about said connected joint enabling the stretching of said muscle without the need to use of any of said muscles associated contracting muscles.
